(19) United States
(12) Patent Application Publication
(10) Pub. No.: US 2009/0102206 A1
(43) Pub. Date: Apr. 23, 2009

(54) DEVICE FOR PREVENTING UNLOCKING OF DOOR HANDLE

(76) Inventor: Jeongmin Lee, Busan (KR)

Correspondence Address: MORGAN, LEWIS & BOCKIUS LLP (SF), One Market, Spear Street Tower, Suite 2800, San Francisco, CA, 94105, US

(21) Appl. No.: 11/959,688

(22) Filed: Dec. 19, 2007

(30) Foreign Application Priority Data
Oct. 22, 2007 (KR) 10-2007-0106265

(51) Int. Cl. E05B 1/00

(52) U.S. Cl. 292/336.3

(57) ABSTRACT

An exemplary embodiment of the present invention, includes: a base body that is disposed onto the outside of a door; a handle that is movable in a pulling direction from base body; a pivot arm that is hinged to base body and unlocks a door ratchet when handle is actuated to open the door; a balance weight that is provided to pivot arm and prevents unlocking of the door ratchet when an inertia force is applied toward the inside of a vehicle; and a locking member that is hinged to connecting arm and prevents unlocking of the door ratchet by restricting movement of handle with respect to base body when an inertia force is applied toward the outside of a vehicle.

### CROSS-REFERENCE TO RELATED APPLICATIONS

The present application is based on, and claims priority from, Korean Application Serial Number 10-2007-0106265, filed on Oct. 22, 2007, the disclosure of which is hereby incorporated by reference herein in its entirety.

### FIELD OF THE INVENTION

The present invention relates to prevent unlocking of a door handle, particularly a device fur preventing unlocking of a door handle to prevent undesired unlocking of a door ratchet by normal and inverse inertia forces generated in a side collision.

### BACKGROUND OF THE INVENTION

In general, a vehicle is equipped with doors for passengers to get on/off and a lock is provided in the doors. In particular, a door handle is provided to the outside of the doors for opening/closing the door. The door handle is equipped with a mechanism to prevent undesired unlocking of door ratchet by a normal inertia force toward the outside of the vehicle and an inverse inertia force toward the inside of the vehicle in a side collision.

For this reason, in the related art, artificial unlocking of a door ratchet by a normal inertia force toward the outside of a vehicle in a side collision is prevented by providing a predetermined weight body to the portion that is involved in unlocking the door ratchet by the handle.

However, the weight body has a limit that it can only to prevent artificial unlocking of the door ratchet only against an inertia force applied in one direction in a side collision.

In particular, both of a normal inertia force toward the outside of a vehicle and an inverse inertia force toward the inside of the vehicle are sequentially exerted in a door in a side collision. Therefore, when the weight of a weight body against the normal inertia force toward the outside of the vehicle is large, it is possible to more securely prevent unlocking of a door ratchet by the normal inertia force, but it causes a problem that the door ratchet is more easily unlocked by the inverse inertia force toward the of the vehicle.

Therefore, not only it is difficult to determine an appropriate weight of the weight body that prevents undesired unlocking of the door ratchet due to inertia forces (normal inertia force and inverse inertia force) applied toward the inside and outside of the vehicle in a side collision together, but it is difficult to meet related laws and regulations that prevents undesired opening of the door in a side collision in designing.

In general, a door handle for opening/closing is provided at doors of a vehicle and the handle has a configuration that prevents undesired unlocking of a door ratchet due to a normal inertia force generated in a side collision.

That is, in a related art as shown in FIG. 1, a base body 1 is disposed onto the outside of a door, a handle 2 is disposed such that it can be pulled from the base body 1, and a pivot arm 4 is disposed to the rear side of the handle 2 such that it can pivot through a connecting arm (not shown).

The middle portion of pivot arm 4 is hinged to a portion of the base body 1 by a hinge 5, an end of the pivot arm 4 is in contact to connecting arm, and the other end of the pivot art 4 is provided with a balance weight 3 having a predetermined weight and connected with a release rod 2 that is connected with a door ratchet (not shown).

In the above configuration of related art, pivot arm 4 is connected to base body 1 through a return spring 7 to apply a return force to the pivot arm 4 in opposite direction to the unlocking direction of the door ratchet.

Therefore, a normal inertia force is applied in a side collision, pivot arm 4 can pivot outwards and thus pull the release rod 6 in order to lock the door ratchet, by an inertia force exerted by balance weight 3.

That is, when a normal inertia force is applied to the outside of the vehicle in a side collision, pivot arm 4 locks the door ratchet by pivoting outwards the balance weight 3 and pulling the release rod 6 upwards.

However, in a side collision, a normal inertia force and an inverse inertia force are alternately applied to pivot arm 30;

Therefore, when an inverse inertia force is applied to the inside of the vehicle, the pivot arm 4 is pivoted inwards about the hinge 5 and thus pushes the release rod 6 downwards so that the door ratchet is unlocked. Accordingly, the door is unexpectedly opened, which causes danger of a secondary accident.

That is, it is advantageous to increase the weight of balance weight 3 to prevent undesired unlocking of the door ratchet using a normal inertia force in a side collision, but in contrast it allows the door ratchet to he more easily unlocked when an inverse inertia force is applied.

Therefore, it is difficult to determine appropriate weight of balance weight to prevent the door from opening unexpectedly by an inertia force in a side collision; therefore, it is very hard to meet related laws and regulations in designing the door that is not unexpectedly opened in a side collision.

The information disclosed in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

It is an object of the present invention to remove danger of a second accident due to opening of a door and meet related laws and regulations by preventing undesired unlocking of a door ratchet by both normal and inverse inertia forces that are exerted in the door in a side collision.

Embodiments of the present invention provide a device for preventing unlocking of a door handle including a handle, a pivot arm, a release rod, a locking member, and a through hole. The handle is disposed such that it can be pulled from a base body and has a connecting arm at the rear side. The pivot arm is hinged to the base body and has an end that is restricted to a protrusion of the connecting arm and the other end with a balance weight. The release rod is connected to the other end of the pivot arm and locks/unlocks a door ratchet. The locking member is hinged to the connecting arm and receives a pivot force such that it contacts to an end of the pivot arm. The through hole is formed through a portion of the base body to receive a free end of the locking member and restrict movement of the handle with respect to the base body.

According to a device for preventing unlocking of a door handle of an exemplary embodiment of the present invention, it is possible to prevent undesired unlocking of a door ratchet by restricting movement of a door handle due to inertia forces using a balance weight, when a normal and inverse inertia forces is applied in a side collision.

Further, it is possible to correspond to related laws and regulations by preventing undesired locking of the door ratchet in a side collision and more positively prevent a secondary accident caused by undesired opening of the door.

The above features and advantages of the present invention will be apparent from or are set forth in more detail in the accompanying drawings, which are incorporated in and form a part of this specification, and the following Detailed Description of the Invention, which together serve to explain by way of example the principles of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view showing the configuration of a device for preventing unlocking of a door handle according to a related art;

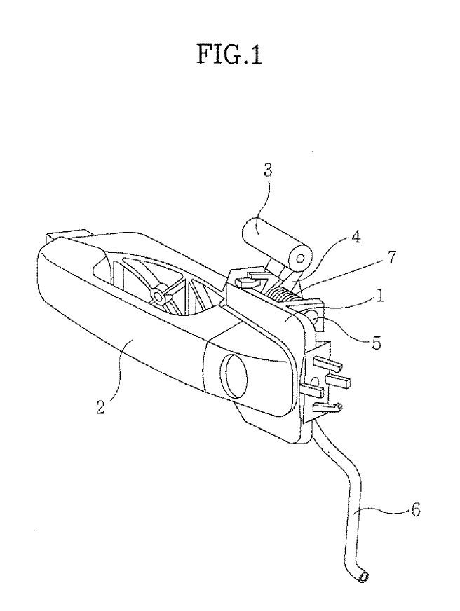

FIG. 2 is a view showing the inside configuration of the device for preventing unlocking of a door handle according to an exemplary embodiment of the present invention;

FIG. 3 is a partial view seen in the direction of “A” of FIG. 2:

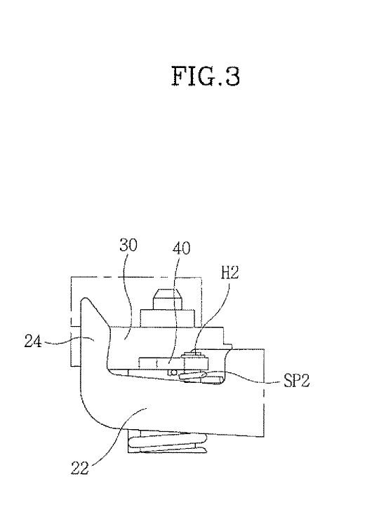

FIG. 4 shows a partial view of a locking member inserted in a through hole of a base body, shown in FIG. 2, and a bottom view thereof, wherein the handle is locked;

FIG. 5 is a view illustrating an operation that prevents unlocking of a door ratchet when a normal inertia force is generated by side collision and applied to the outside of the vehicle while the handle is locked;

FIG. 6 is a view illustrating an operation that prevents unlocking of a door ratchet when an inverse inertia force is generated by side collision and applied to the inside of the vehicle while the handle is locked; and

FIG. 7 is a view illustrating relationship of motions of a locking member and a pivot arm shown in FIG. 6.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE PREFERRED EMBODIMENTS

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

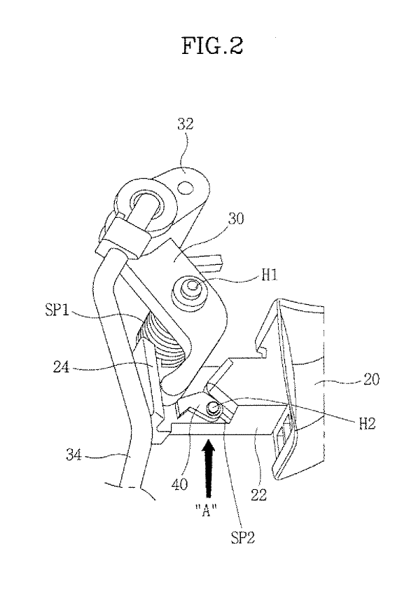

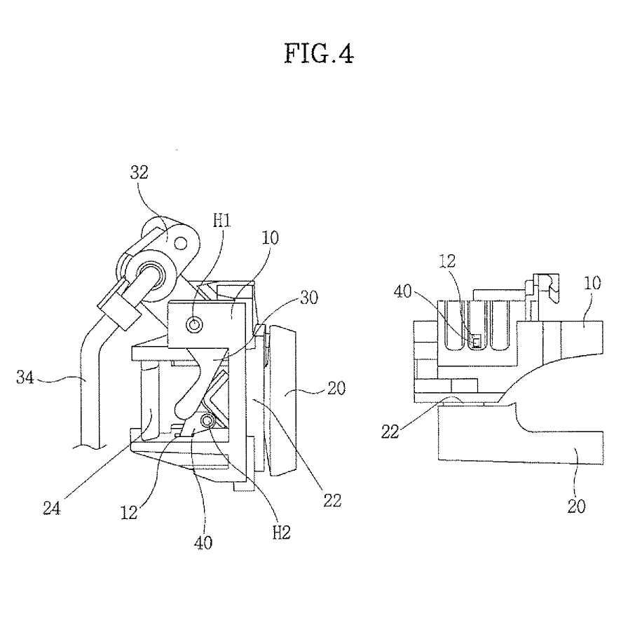

As shown in FIGS. 2 and 4, a device for preventing unlocking of a door handle according to an exemplary embodiment of the present invention includes a base body 10, a handle 20, a pivot arm 30, and a locking member 40.

Base body 10 is disposed onto the outside of a door. Handle 20 is connected to a proximate end portion of a connecting arm 22 positioned in the rear side of the base body 10.

The handle 20 can be pulled from the base body 10 by a user when the door opens and constitutes a grip-typed outer handle of the door together within the base body 10.

Further, a pivot arm 30 is provided in the rear side of the base body 10 and a middle portion of the pivot arm 30 is pivotably mounted to a portion of the base body 10 by a hinge H1.

The pivot arm 30 is disposed such that a proximate end portion of the pivot arm 30 is engaged with the connecting arm 22 of the handle 20 via a locking member 40.

A distal end portion of the pivot arm 30 is connected to a balance weight 32 having a predetermined weight.

Further a release rod 34 that unlocks or locks a door ratchet (not shown) when a user pull or push the handle 20, is connected to the distal end portion of the pivot arm 30.

Locking member 40 is provided between the pivot arm 30 and an end of the locking member 40 is hingedly connected to the connecting arm 22 by a hinge H2 positioned at a side of connecting arm 22, particularly, near a middle portion of the connecting arm 22. The other end of the locking member 40 is a free end and selectively coupled to a portion of the base body 10 as explained next.

The rocking member 40 may be locked or unlocked to the base body 10 by operation of the proximate end portion of the pivot am 30 since the free end of locking member 40 can rotate pivotally clockwise or counterclockwise about the hinge H2.

Hereinafter, the rocking or unlocking mechanism in accordance with a state that an inverse inertia force is applied to the inside of a vehicle in a side collision, a normal state that the door handle is pulled by a user, and a state that normal inertia force is applied to the outside of a vehicle in a side collision, are explained.

First, a state that an inverse inertia force is applied to the inside of a vehicle in a side collision is explained in detail.

FIG. 4 shows that the door is closed and thus the handle 20 is pushed inward the door of the vehicle.

Referring to FIG. 4, when all inverse inertia force is applied to the inside of the vehicle in a side collision, a moment of inertia of the balance weight 32 on which the distal aid portion of the pivot arm 30 is attached is applied counterclockwise in the drawing. Accordingly the proximate end portion of the pivot arm 30 pushes the free end of the locking member 40 pivotally with respect to the hinge H1. Hence, the free end of locking member 40 pivotally rotates about hinge H2 and is pushed into a through hole 12 positioned at a portion of the base body 10 by operation of the proximate end portion of the pivot arm 30.

The pushed locking member 40 is locked to the base body 10, thereby the release rod 34 on which the distal end portion of the pivot are 30 is coupled, is not pushed downward to unlock the door ratchet (not shown). As a result, the door ratchet kept locked to close the door. Furthermore, since the locking member 40 is locked into the base body, the handle 20 cannot move outwards with respect to the base body 10.

In order to achieve the above operation, a through hole 12 that restricts the movement of handle 20 with respect to the base body 10 by receiving the free end of locking member 40 is formed through a portion of the base body 10. In this embodiment, the through hole 12 is positioned on a position of the base body 10 crossing the downward pivoting path of locking member 40 to receive the tree end of locking member 40 as shown in FIG. 4.

Further, a return spring SP1 that provides a return force to the pivot arm 30 is provided to the hinge H1. The return force provided to the pivot arm 30 by return spring SP1 is applied in the opposite direction to unlocking direction of the door ratchet of release rod 34.

Secondly, the normal state that the door handle is pulled by a user is explained.

The device for preventing unlocking of a door handle further includes a protrusion 24. The protrusion 24 that restricts the movement of the proximate end portion of the pivot arm 30 is formed at a distal end portion of the connecting arm 22.

When handle 20 is pulled outwards from the base body 10 in a normal state to open the door, the locking member 40 is unlocked from the through hole 12 because the locking member 40 moves with the connecting arm 22 together and thus rotates counterclockwise about the hinge 12b.

Furthermore, as the handle 20 is pulled from base body 10 outwards to open the door, the proximate end portion of pivot arm 30 is pulled outwards by the protrusion 24 of connecting arm 22 and the distal end portion of the pivot arm 30 pushes the release rod 34 downward while the locking member 40 pivotally rotates counterclockwise about hinge H2, such that the door ratchet is unlocked.

In addition, a return spring SP2 that provides a return force to contact the free end of locking member 40 to the proximate end portion of pivot arm 30 is provided to hinge H2. Therefore, the locking member 40 is pivoted counterclockwise about the hinge H2 by the return force of return spring SP2 such that the return spring SP2 always contacts to the free end of locking member 40.

Lastly, a state that normal inertia force is applied is explained in detail.

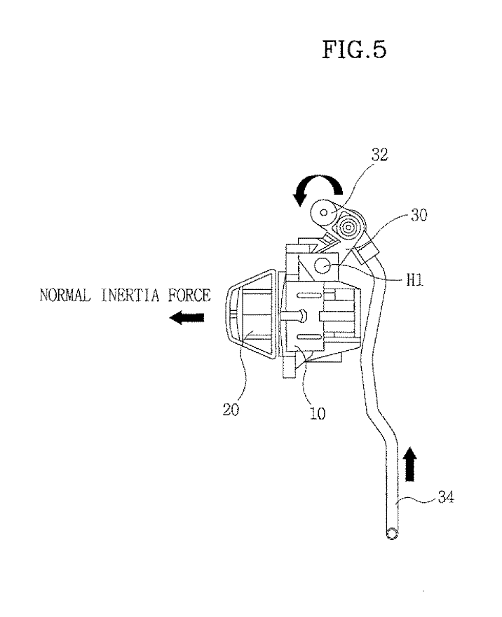

When a normal inertia force toward the outside of a vehicle is generated in a side collision, as shown in FIG. 5, the pivot arm 30 pivotally rotates about the hinge H1 counterclockwise by the moment of inertia of the balance weight 32 in the drawing such that the release rod 34 is pulled upward; therefore, the door ratchet is not unexpectedly unlocked.

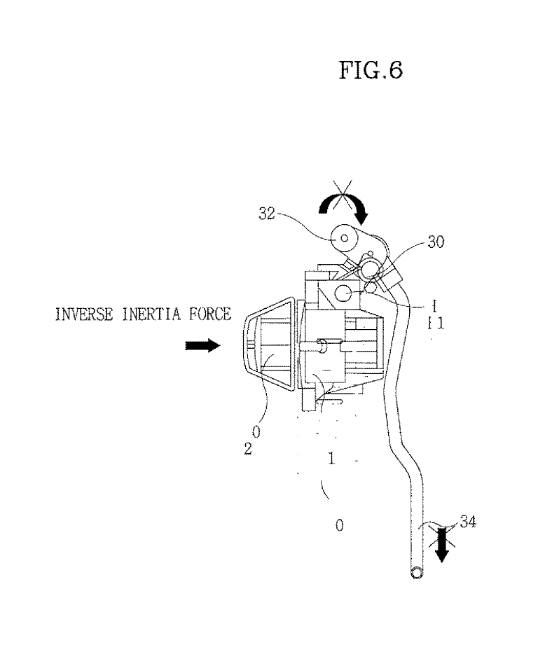

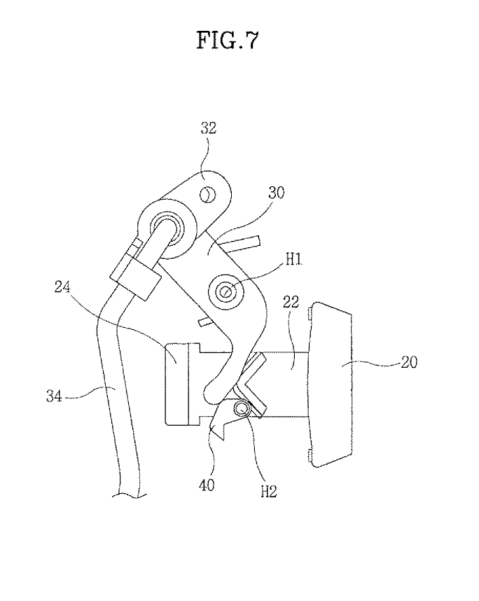

On the other hand, FIGS. 6 and 7 shows when an inverse inertia force toward the inside of a vehicle is generated in a side collision.

In this case pivot arm 30 cannot rotate about hinge H1 since the proximate end portion of the pivot arm 30 is locked by the rocking member which is locked into a through hole 20, such that the release rod 34 cannot be pushed downwards by the distal end portion of the pivot arm although locking member 40 is pushed by the proximate end portion of the pivot arm 30. The rocking member 40 kept to be inserted into through hole 12 of base body 10 (shown in FIG. 4). Therefore the movement of handle 20 with respect to base body 10 is restricted.

As a result, even though pivot arm 30 pivots, handle 20 cannot moved by restriction of locking member 40 therefore, the door ratchet is not unexpectedly unlocked.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that technical spirit and scope of the present invention be defined by the Claims appended hereto and their equivalents.

What is claimed is:

1. A device for preventing unlocking of a door handle comprising:
a base body that is disposed onto an outside of a door;
a connecting arm of the door handle that is movable in a pulling direction from the base bode;
a pivot arm wherein an distal end portion of the pivot arm is coupled to a door ratchet and the pivot arm is hinged to a portion of the base body to unlock the door ratchet when an inverse inertia force is applied to an inside of an vehicle or all inertia force is applied to an outside of the vehicle;
a balance weight that is provided to the distal end portion of the pivot arm; and
a locking member that is hinged to a portion of the connecting arm and restricts movement of the handle with respect to the base body when the inverse inertia force is applied to the inside of the vehicle or the inertia force is applied to the outside of the vehicle.

2. The device as defined in claim 1, wherein the locking member is locked to the base body by the pivot arm and pivoting when the inverse inertia force is applied to the inside of the vehicle or the inertia force is applied to the outside of the vehicle.

3. The device as defined in claim 2, wherein a through hole that locks a free end of the locking member is formed through the base body.

4. The device as defined in claim 3, wherein the through hole is positioned on a portion of the base body crossing a downward pivoting path of the locking member to receive the free end of the locking member.

5. The device as defined in claim 1, wherein the connecting arm having a protrusion that pulls a proximate end portion of the pivot arm when the door is opened is provided to a rear side of the handle; and
the locking member is disposed pivotably up/down with respect to the connecting arm.

6. The device as defined in claim 3, wherein a return spring that provides a return force for contacting the free end of the locking member to an distal end of the pivot arm is provided to the hinge of the locking member.

7. The device as defined in claim 1, wherein a return spring that provides a return force for the pivot arm is provided to a hinge of the pivot arm.
